(19) United States
(12) Patent Application Publication
(10) Pub. No.: US 2008/0061612 A1
(43) Pub. Date: Mar. 13, 2008

(54) Reclining Vehicle Infant Seat

(76) Inventor: Irene J. Crampton, Santa Clarita, CA (US)

Correspondence Address: KENNETH L. TOLAR, 2908 Hessmer Avenue, Metairie, LA, 70002, US

(21) Appl. No.: 11/851,829

(22) Filed: Sep. 7, 2007

Related U.S. Application Data
(60) Provisional application No. 60/842,912, filed on Sep. 7, 2006.

(51) Int. Cl. B60N 2/26

(52) U.S. Cl. 297/256.13

(57) ABSTRACT

A reclining infant seat includes a base component having a chair member mounted thereon. The base component includes a pair of motor-driven gears that engage a pair of geared tracks on the lower surface of the chair member whereby operation of the motor moves the chair member upwardly to an upright position or downwardly to a reclined position. The motor may be operated locally or remotely allowing an operator to easily recline the chair member to prevent a sleeping infant's head from tilting or wobbling.

### CROSS REFERENCE TO RELATED APPLICATIONS

This application is entitled to the benefit of provisional application No. 60/842,912 filed on Sep. 7, 2006, the specification of which is incorporated herein by reference.

### BACKGROUND OF THE INVENTION

The present invention relates to a remotely-controlled, reclining infant seat for a vehicle.

### DESCRIPTION OF THE PRIOR ART

When a child is secured within a conventional vehicle child seat, his or her head may wobble or tilt when the child falls asleep. The head movement can cause severe discomfort, muscle strain and even whiplash or other serious injuries if the driver is involved in an accident. Accordingly, there is currently a need for a device that prevents a child's head from wobbling or tilting while seated in an infant seat. The present invention satisfies this need by providing a uniquely designed infant seat that can be reclined when the child falls asleep.

### SUMMARY OF THE INVENTION

The present invention relates to a reclining infant seat including a base component having a chair member mounted thereon. The base component includes a pair of motor-driven gears that engage a pair of geared tracks on the lower surface of the chair member whereby operation of the motor moves the chair member between an upright and a reclined position. The motor may be activated either locally or remotely allowing an operator to easily recline the chair member to prevent a sleeping infant's head from tilting or wobbling.

It is therefore an object of the present invention to provide an infant seat that prevents a child's head from wobbling or tilting.

It is another object of the present invention to provide an infant seat that may be automatically reclined with a remote control.

Other objects, features, and advantages of the present invention will become readily apparent from the following detailed description of the preferred embodiment when considered with the attached drawings and the appended claims.

### BRIEF DESCRIPTION OF THE DRAWINGS

FIG. 1 is a side view of the infant seat according to the present invention in an upright position.

FIG. 2 is a side view of the infant seat in a reclined position.

FIG. 3 is a detailed view of the geared tracks on the lower surface of the chair member.

FIG. 4 is a top view of the motor-operated gear system.

FIG. 5 depicts the remote unit.

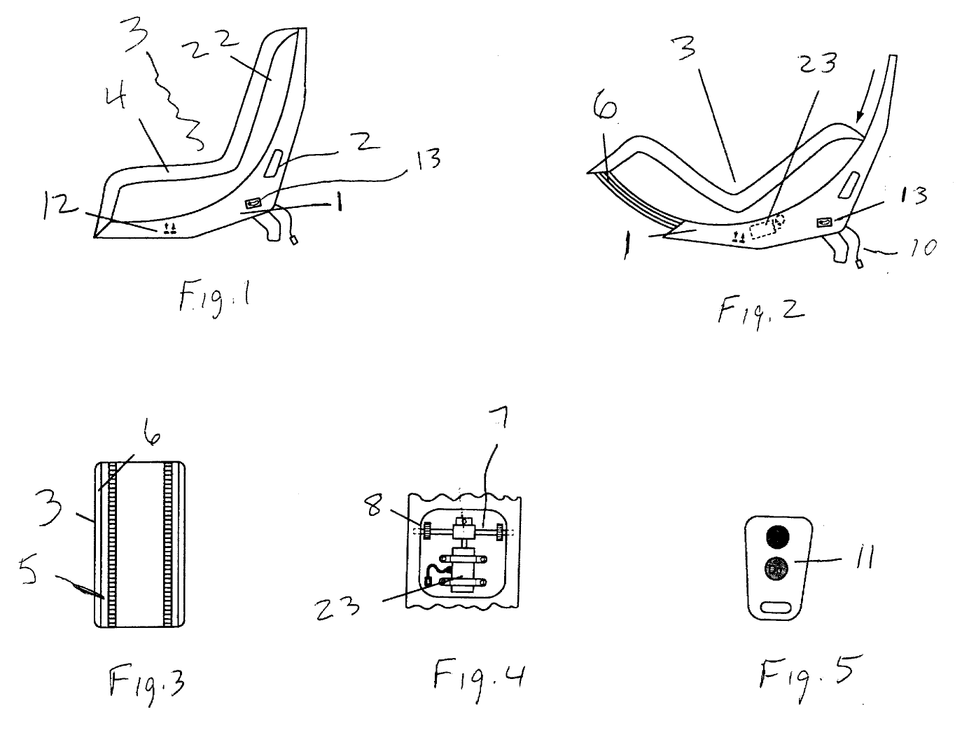

### DESCRIPTION OF THE PREFERRED EMBODIMENT

The present invention relates to a reclining infant seat. The device comprises a base component 1 preferably constructed with a rigid material such as plastic. The base component includes openings 2 on a rear portion for receiving a seatbelt to secure the base component within a vehicle passenger seat. Preferably, a bubble level 13 is positioned on a side of the base component to assist a user in properly orienting the infant seat within a vehicle passenger seat.

Superimposed on the base component is a chair member 3 having a seat portion 4 with a backrest portion 22 vertically extending therefrom. The chair member includes a rear surface having a pair of spaced, geared tracks 5 positioned thereon. The chair member also includes an arcuate ridge 6 extending along each of two opposing sides thereof, each ridge riding within a similarly shaped groove formed on the inner surface of the base component.

The base component further includes a drive system comprising a DC motor 23 driven axle 7 having a pair of opposing rotary gears 8 thereon. The rotary gears each engage one of the geared tracks on the chair member such that rotation of the axle moves the chair member upwardly or downwardly relative to the base component.

At two opposing ends of each geared track is an optical switch that disengages the motor to prevent the chair member from being completely ejected from the base component. Furthermore, when the DC motor is disabled, a solenoid-operated pin extends to lock the chair member onto the base component. When the motor is re-engaged, the pin is automatically retracted.

A power cable 10 with a special connector at a distal end establishes electrical communication between the motor and the vehicle's electrical system. The motor is controlled remotely with a wireless remote unit 11 or manually with control buttons 12 positioned on the base component. As such, the motor includes an associated microcontroller, a wireless receiver and driver electronics that respond to digitally encoded signals from the remote unit.

The above described device is not limited to the exact details of construction and enumeration of parts provided herein. Furthermore, the size, shape and materials of construction of the various components can be varied.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A reclining infant seat comprising:
a base component;
a chair member superimposed on the base component;
a reclining means for moving said chair member between a substantially upright position and a reclined position to prevent a sleeping infant's head from tilting.

2. The infant seat according to claim 1 further comprising openings on a rear portion of said base component for receiving a seatbelt to secure the base component within a vehicle passenger seat.

3. The infant seat according to claim 1 wherein said means for moving said chair member between a substantially upright position and a reclined position comprises:
a pair of spaced, geared tracks positioned on a rear surface of said chair member;
a motor-driven axle having a pair of opposing rotary gears thereon, each of said gears engaging one of the geared tracks on said chair member whereby rotation of the axle moves the chair member upwardly and downwardly relative to the base component.

4. The infant seat according to claim 3 further comprising an arcuate ridge extending along each of two opposing sides of said chair member, each ridge riding within a mating groove formed on an inner surface of the base component.

5. The infant seat according to claim 1 further comprising means for disabling said reclining means upon said chair member moving beyond a predetermined distance relative to said base component.

6. The infant seat according to claim 1 further comprising a looking means for locking said chair member at a select position on said base component.

7. The infant seat according to claim 1 further comprising a control means for controlling said reclining means.

8. The infant seat according to claim 1 further comprising a level on said base component that assists a user in properly orienting the base component within a vehicle passenger seat.
